(19) United States
(12) Patent Application Publication
(10) Pub. No.: US 2010/0252543 A1
(43) Pub. Date: Oct. 7, 2010

(54) LASER-SCRIBING TOOL ARCHITECTURE

(75) Inventors: Antoine P. Manens, Saratoga, CA (US); Wei-Yung Hsu, Santa Clara, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/621,316

(22) Filed: Nov. 18, 2009

Related U.S. Application Data
(60) Provisional application No. 61/116,257, filed on Nov. 19, 2008.

(51) Int. Cl. B23K 26/00

(52) U.S. Cl. 219/121.69; 219/121.68

(57) ABSTRACT

The present disclosure relates to apparatuses and systems for laser scribing a vertically-oriented workpiece. In many embodiments, a laser-scribing apparatus includes a frame, a first fixture coupled with the frame, a second fixture coupled with the frame, a laser operable to generate output able to remove material from at least a portion of the workpiece, and a scanning device coupled with the laser and the frame. The first fixture is configured for engagement with a first portion of the workpiece. The second fixture is configured for engagement with a second portion of the workpiece. When the workpiece is engaged by the first and second fixtures the workpiece is substantially vertically oriented. The scanning device is operable to control a position of the output from the laser relative to the workpiece.

### CROSS-REFERENCES TO RELATED APPLICATIONS

This application claims the benefit of U.S. Provisional Patent Application No. 61/116,257, filed on Nov. 19, 2008, entitled “Laser Scribing Tool Architecture,” the entire disclosure of which is hereby incorporated herein by reference.

### BACKGROUND

Various embodiments described herein relate generally to apparatuses and systems for scribing or patterning a workpiece, and more particularly to apparatuses and systems for laser scribing a workpiece placed in a vertical orientation. Such apparatuses and systems can be particularly effective for laser scribing glass substrates having at least one layer used to form thin-film solar cells.

Current methods for forming thin-film solar cells involve depositing or otherwise forming a plurality of layers on a substrate, such as a glass, metal or polymer substrate suitable to form one or more p-n junctions. An example thin-film solar cell includes a glass substrate having a transparent-conductive-oxide (TCO) layer, a plurality of doped and undoped silicon layers, and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” the entire disclosure of which is hereby incorporated herein by reference.

When a panel is formed from a large substrate, a series of laser-scribed lines is typically used within each layer to delineate individual cells. FIG. 1 diagrammatically illustrates an example solar-cell assembly 10 that includes scribed lines, for example, laser-scribed lines. The solar-cell assembly 10 can be fabricated by depositing a number of layers on a glass substrate 12 and scribing a number of lines within the layers. The fabrication process begins with the deposition of a TCO layer 14 on the glass substrate 12. A first set of lines 16 (“P1” interconnect lines and “P1” isolation lines) are then scribed within the TCO layer 14. A plurality of doped and undoped amorphous silicon (a-Si) layers 18 are then deposited on the TCO layer 14 and within the first set of lines 16. A second set of lines 20 (“P2” interconnect lines) are then scribed within the silicon layers 18. A metal layer 22 is then deposited on the silicon layers 18 and within the second set of lines 20. A third set of lines 24 (“P3” interconnect lines and “P3” isolation lines) are then scribed as illustrated.

The cost of production and quality of thin-film solar cells are influenced by the cost of production and quality of the scribed assemblies (e.g., solar-cell assembly 10) used to produce the solar cells. Accordingly, it is desirable to develop apparatuses and systems for scribing workpieces that have reduced cost and improved scribing quality. More particularly, it is desirable to develop improved apparatuses and systems for laser-scribing assemblies used to form thin-film solar cells.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some aspects and embodiments in a simplified form as a prelude to the more detailed description that is presented later.

Apparatuses and systems in accordance with various aspects and embodiments are provided for laser scribing a workpiece. The disclosed apparatuses and systems are configured to laser scribe a vertically-oriented workpiece. Vertically orienting the workpiece may result in improved workpiece stability, improved ablation debris removal, improved throughput, reduced vibration levels, improved accuracy, smaller footprint, improved serviceability, and/or other such improvements. Such apparatuses and systems may be particularly effective when used to laser scribe assemblies used to form thin-film solar cells.

In a first aspect, an apparatus for laser scribing a workpiece comprising a substantially flat surface is provided. The apparatus includes a frame, a first fixture coupled with the frame, a second fixture coupled with the frame, a laser operable to generate output able to remove material from at least a portion of the workpiece, and a scanning device coupled with the laser and the frame. The first fixture is configured for engagement with a first portion of the workpiece. The second fixture is configured for engagement with a second portion of the workpiece. When the workpiece is engaged by the first and second fixtures the flat surface is substantially vertically oriented. The scanning device is operable to control a position of the output from the laser relative to the workpiece.

In many embodiments, the first and second fixtures are configured to engage different portions of a rectangular workpiece. For example, the first fixture can be configured to engage the workpiece along a first side and the second fixture can be configured to engage the workpiece along a second side opposite the first side. When the workpiece is engaged by the first and second fixtures, the first side can be disposed at the top of the workpiece and the second side can be disposed at the bottom of the workpiece. Additionally, when the workpiece is engaged by the first and second fixtures, the first and second sides can be substantially vertically oriented.

In many embodiments, the fixtures can be translatable relative to the frame and the apparatus can comprise additional fixtures. For example, the first and second fixtures can be horizontally translatable relative to the frame. The apparatus can comprise third and fourth fixtures coupled with the frame. The third fixture can be configured to engage a second workpiece along a first side of the second workpiece. The fourth fixture can be configured to engage the second workpiece along a second side of the second workpiece. When the second workpiece is engaged by the third and fourth fixtures a flat surface of the second workpiece is substantially vertically oriented. The third and fourth fixtures can be horizontally translatable relative to the frame.

In many embodiments, the apparatus can be configured to hold multiple workpieces. For example, in many embodiments, a workpiece can be loaded or unloaded while another workpiece is being scribed. A path of travel in the apparatus for a workpiece can be offset from a path of travel in the apparatus for a second workpiece.

In many embodiments, the scanning device is translatable relative to the workpiece and/or the frame. For example, the scanning device can be horizontally translatable so as to adjust for an offset between the paths of travel for the workpiece and the second workpiece. Such offset adjustment can also be achieved by changing the focus of the beam by optical means, such as with a three-dimensional scanner, and/or an adjustable beam expander. The scanning device can be vertically translatable relative to the workpiece and/or the frame.

In many embodiments, the apparatus comprises multiple scanning devices. For example, the apparatus can comprise a second scanning device coupled with the laser and the frame. The second scanning device is operable to control a position of the output from the laser relative to the workpiece. Both the scanning device and the second scanning device can be vertically translatable relative to the workpiece.

In many embodiments, the apparatus comprises one or more optical cables. For example, the apparatus can comprise an optical cable coupling the laser with the scanning device and can comprise a second optical cable coupling the laser with the second scanning device.

In many embodiments, the workpiece comprises a substrate and at least one layer used for forming a solar cell. In many embodiments, the laser is able to remove material from the at least one layer.

In another aspect, a system for laser scribing a workpiece comprising a substantially flat surface is provided. The system includes a frame, a first fixture coupled with the frame, a second fixture coupled with the frame, a laser operable to generate output able to remove material from at least a portion of the workpiece, a scanning device coupled with the laser and the frame, and a control device coupled with the laser and the scanning device. The first fixture is configured for engagement with a first portion of the workpiece. The second fixture is configured for engagement with a second portion of the workpiece. When the workpiece is engaged by the first and second fixtures, the flat surface is substantially vertically oriented. The scanning device is operable to control a position of the output from the laser relative to the workpiece. The control device includes a processor and a machine-readable medium. The machine-readable medium includes instructions that when executed by the processor cause the system to align the laser output in order to form a predetermined feature pattern on the workpiece.

In many embodiments, the scanning device and the workpiece are translatable. For example, the scanning device can be vertically translatable relative to the workpiece. The first and second fixtures can be horizontally translatable relative to the frame.

In another aspect, a method for laser scribing a workpiece comprising a substantially flat surface is provided. The method includes supporting the workpiece so that the flat surface is substantially vertically oriented, generating a relative translation between the supported workpiece and a scribing optical assembly, and directing output from a laser with the scribing optical assembly during the relative translation to form a laser-scribed feature on the workpiece. The relative translation comprises a vertical component. In many embodiments, the relative translation further comprises a horizontal component.

In many embodiments, the workpiece is supported by a frame. For example, the workpiece can be supported with a first fixture engaged with a first portion of the workpiece and a second fixture engaged with a second portion of the workpiece, where the first and second fixtures are coupled with the frame and configured to be horizontally translatable relative to the frame. The scribing optical assembly can be coupled with the frame. In many embodiments, the workpiece is translated horizontally relative to the frame during at least a portion of the formation of the laser-scribed feature. In many embodiments, the method further comprises mounting a second workpiece so that the second workpiece is supported by the frame during at least a portion of the formation of the laser-scribed feature.

In many embodiments, the workpiece comprises a substrate and at least one layer used for forming a solar cell. In many embodiments, the laser is able to remove material from the at least one layer.

For a fuller understanding of the nature and advantages of the present invention, reference should be made to the ensuing detailed description and the accompanying drawings. Other aspects, objects and advantages of the invention will be apparent from the drawings and the detailed description that follows.

### BRIEF DESCRIPTION OF THE DRAWINGS

FIG. 1 is a schematic illustration of a scribed assembly used in a thin-film solar cell.

FIG. 2A is a front-view schematic illustration of a laser-scribing apparatus for scribing a vertically-oriented workpiece, in accordance with many embodiments.

FIG. 2B is a top-view schematic illustration of a laser-scribing apparatus for scribing a vertically-oriented workpiece, in accordance with many embodiments.

FIG. 3A schematically illustrates positions of first and second workpieces in a processing sequence that can be used to laser scribe vertically-oriented workpieces, in accordance with many embodiments.

FIG. 3B schematically illustrates positions of first and second workpieces in a processing sequence that can be used to laser scribe vertically-oriented workpieces, in accordance with many embodiments.

FIG. 3C schematically illustrates positions of second and third workpieces in a processing sequence that can be used to laser scribe vertically-oriented workpieces, in accordance with many embodiments.

FIG. 4 schematically illustrates laser-scanning assemblies configured for vertical translation relative to a vertically-oriented workpiece, in accordance with many embodiments.

FIG. 5A schematically illustrates components of a laser assembly, in accordance with many embodiments.

FIGS. 5B and 5C schematically illustrate components of a laser-optics module, in accordance with many embodiments.

FIG. 6 schematically illustrates the use of a beam viewer to measure the position of a laser beam, in accordance with many embodiments.

FIG. 7 schematically illustrates the integration of an imaging device with a laser-scanning assembly, in accordance with many embodiments.

FIG. 8 schematically illustrates the integration of a camera with a laser-scanning assembly, showing locations for photodiodes that can be used to measure laser-pulse reflections and illumination source locations, in accordance with many embodiments.

FIG. 9 diagrammatically illustrates signals between components of a laser-scribing system, in accordance with many embodiments.

FIG. 10 illustrates a control diagram for a laser-scribing device that can be used in accordance with many embodiments.

FIG. 11 illustrates a data-flow diagram for a laser-scribing device that can be used in accordance with many embodiments.

FIG. 12 is a simplified diagram of a system for controlling a scanning device based upon image information of previously formed features, in accordance with many embodiments.

### DETAILED DESCRIPTION

In accordance with various aspects and embodiments of the present disclosure, apparatuses and systems for scribing or otherwise patterning a vertically-oriented workpiece are provided. Laser scribing a vertically-oriented workpiece, for example, may result in improved workpiece stability, improved ablation debris removal, improved throughput, reduced vibration levels, improved accuracy, and other such improvements. For example, laser scribing a vertically-oriented workpiece may reduce the need for air bearings to support the workpiece, which may make it possible to stack two or more workpieces close together, which may enable increased throughput. Such apparatuses and systems may be particularly effective when used to laser-scribe assemblies used to form thin-film solar cells.

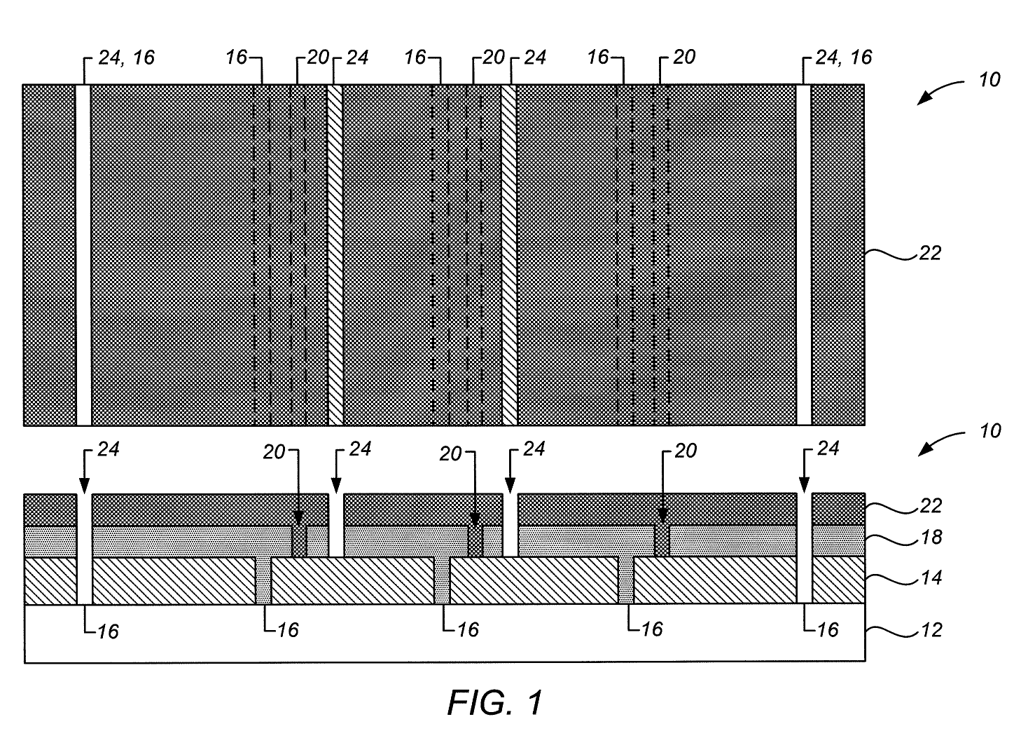

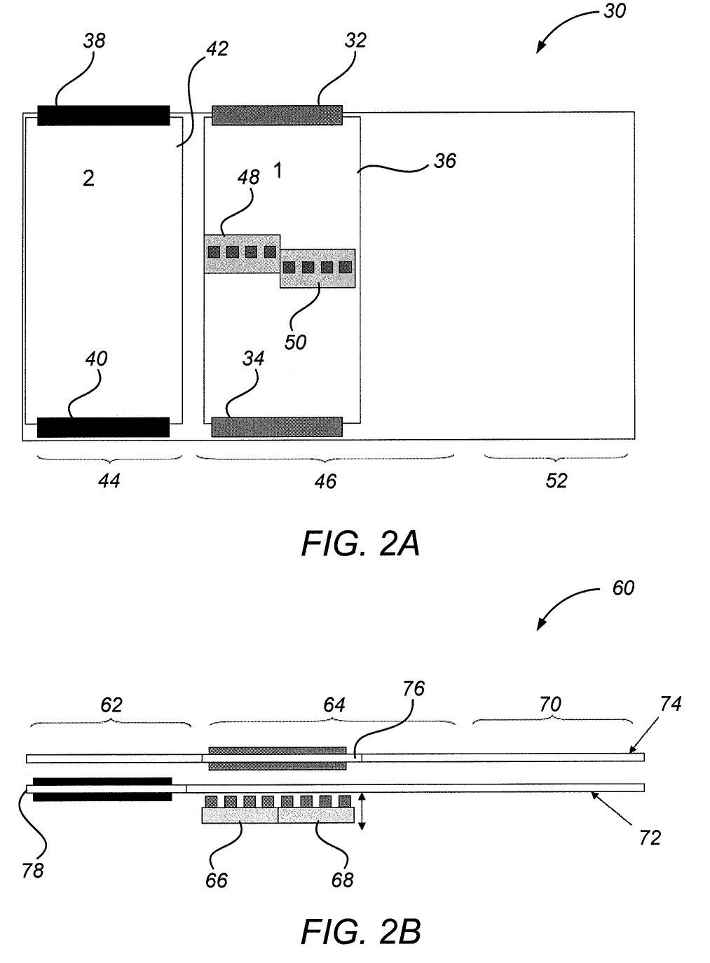

FIG. 2A schematically illustrates a front view of a laser-scribing tool architecture 30 that can be used in accordance with many embodiments to laser scribe or otherwise pattern a vertically-oriented workpiece, such as the example solar-cell assembly 10 discussed above (shown in FIG. 1). The tool architecture 30 can include a first fixture 32 and a second fixture 34 for holding a first workpiece 36 in a vertical orientation. The holding fixtures can include any appropriate gripper, clamping device, grasping device, or other such device. The tool architecture 30 can also include additional fixtures, such as a third fixture 38 and a fourth fixture 40 shown, for holding one or more additional workpieces in a vertical orientation (e.g., a second workpiece 42). Two fixtures can be arranged to engage opposite sides or edges of a rectangular workpiece, for example, by engaging the top and bottom sides or by engaging the left and right sides. Four or more fixtures can be arranged to engage all four sides of a rectangular workpiece. Although as little as one fixture can be used, the use of two or more fixtures may provide increased workpiece stability.

In many embodiments, the tool architecture 30 includes a first loading/unloading station 44, a scribing station 46, a first scribing optical assembly 48, a second scribing optical assembly 50, and a second loading/unloading station 52. These separate stations provide the ability to load and/or unload a workpiece while another workpiece is being scribed. For example, in FIG. 2A the first workpiece 36 can be scribed while the second workpiece 42 is loaded into the scribing tool via the first loading/unloading station 44. Although not shown, another workpiece positioned at the second loading/unloading station 52 can be unloaded while the first workpiece 36 is being scribed and the second workpiece 42 is being loaded. It should be understood that the workpieces can travel in either direction. For example, the second loading/unloading station 52 can be used to unload a workpiece that moved left to right in the plane of the figure (e.g., from the scribing station 46 to the second station 52). The second station 52 can then be used to load another workpiece, which would then move from right to left in the plane of the figure (e.g., from the second station 52 to the scribing station 46). In many embodiments, the fixtures move back to a designated loading station after a workpiece is unloaded at a designated unloading station such that workpieces are always loaded at the designated loading station and unloaded at the designated unloading station. In many embodiments where a single rail is used, each loading/unloading station can serve as a loading and unloading station for a workpiece. For example, a workpiece loaded via the first loading/unloading station 44 can move to the right to the scribing station 46 and then move back to the left to be unloaded at the first loading/unloading station 44, thereby never reaching the second loading/unloading station 52. In such an approach, the second loading/unloading station 52 can be occupied by the fixtures 32, 34 for use in supporting a workpiece loaded and unloaded via the second loading/unloading station 52. In many embodiments where a single rail is used, the fixtures cannot pass each other on the same rail, so fixture 38 is necessarily always to the left of fixture 32 in the figure. In many embodiments, separate rails are used as discussed below.

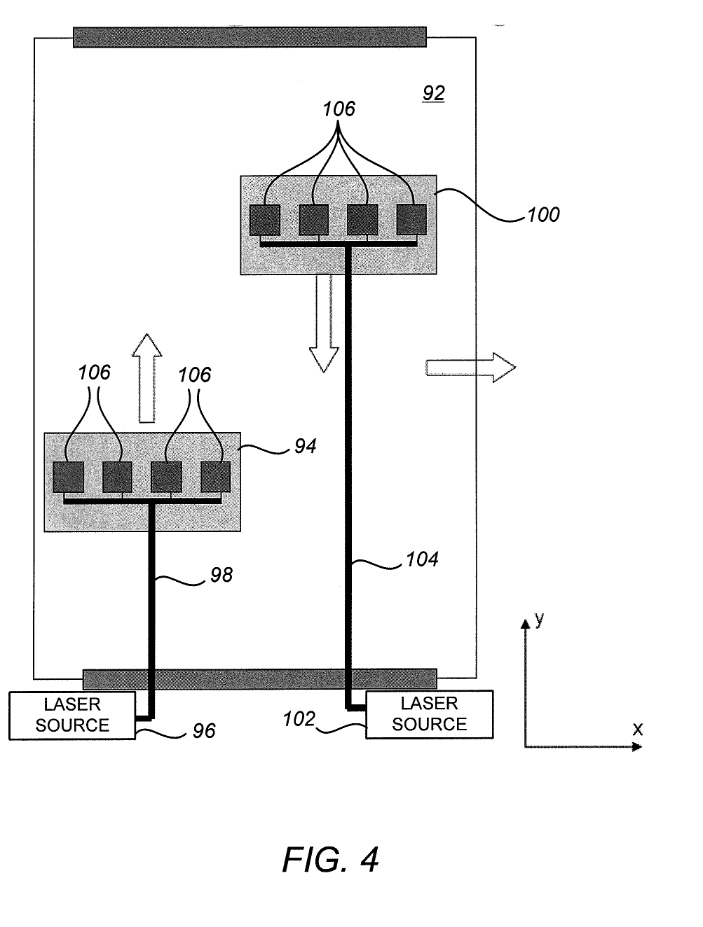

In many embodiments, a first scribing optical assembly 48 and a second scribing optical assembly 50 are configured to translate vertically relative to the workpiece so as to provide a desired area of coverage on the workpiece. Each scribing optical assembly can be coupled with one or more lasers (see FIG. 4) via an optical path, for example, via an optical path comprising an optical fiber or other optical element. Each optical assembly also can include one or more laser scanning heads (e.g.; a one, two, or three-dimensional scanner able to direct each beam in one, two, or three dimensions, respectively) that provide the ability to control the position of the output of a laser beam relative to each scanning head. In many embodiments, there is one laser for each scanner, while in many other embodiments a laser beam is split into multiple beams, such as by using an appropriate beam-splitting element, which can be directed to different scanners. In many embodiments, only a single laser is used. In many embodiments that use optical fibers, the optical fibers can be selected to such that the optical path length is the substantially equivalent for each scanner.

FIG.2B schematically illustrates a top-view of a laser-scribing tool architecture 60 in accordance with many embodiments, that utilizes a frame with separate, substantially parallel rails or tracks 72, 74. In many embodiments, the tool architecture 60 is a variation of the tool architecture 30 shown in FIG. 2A, and thus can contain many of the same or similar components. The tool architecture 60 includes a first loading/unloading station 62, a scribing station 64, a first scribing optical assembly 66, a second scribing optical assembly 68, a second loading/unloading station 70, and what will be referred to herein as a “front” workpiece track 72 and a “back” workpiece track 74, although these designations should not infer any particular or preferred orientation. The separate workpiece tracks may allow a workpiece to be loaded or unloaded on one track while another workpiece is being processed (e.g., scribed or patterned) on the other track. The use of separate workpiece tracks may reduce the transmission of vibrations to a workpiece that is being scribed on one track by providing for the ability to load and/or unload workpieces on the other track. For example, a first workpiece 76 can be scribed while secured to the back workpiece track 74 while a second workpiece 78 can be loaded via the front workpiece track 72. The first scribing optical assembly 66 and the second scribing optical assembly 68 can be configured to move horizontally (in a direction transverse to the direction of motion of the workpieces) so as to be positioned at the same distance from a workpiece regardless of what track the workpiece is on. For example, in the plane of the figure the optics move “up” toward the back track 74 to process the first workpiece 76 on the back track, but would move back “down” away from the back track to process the second workpiece 78 on the front track 72.

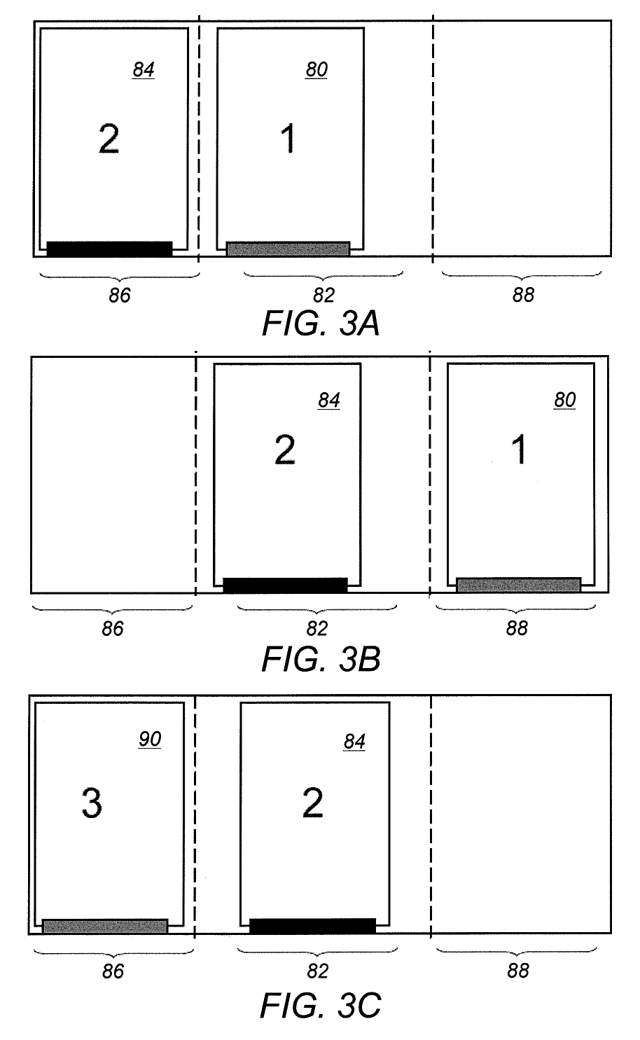

FIGS. 3A, 3B, and 3C schematically illustrate a processing sequence, in accordance with many embodiments, for laser-scribing vertically-oriented workpieces. In FIG. 3A, a first workpiece 80 can be loaded via a first loading/unloading station 86 onto a first track (e.g., a front track) and then moved continually to the right in the figure to be scribed in the scribing station 82. During scribing of the first workpiece 80, a second workpiece 84 can be loaded via station 86 onto a second track (e.g., a back track). Each workpiece can be aligned in station 86 using one or more previously formed features. Optionally, a workpiece can be marked with bar coding and/or other designating marks for use in alignment. In FIG. 3B, the first workpiece 80 can be unloaded at a second loading/unloading station 88 after being processed, while the second workpiece 84 can be scribed in the scribing station 82. In many embodiments, a workpiece can be held stationary or translated during any particular portion of the scribing process. As discussed, the optics or scan heads can be adjusted horizontally (toward or away from the workpiece) to maintain a substantially constant distance from each workpiece being processed. As illustrated in FIG. 3C, the fixtures on the first track can move back to the station 86 such that a third workpiece 90 can be loaded (and optionally aligned and/or marked) in the station 86 while the second workpiece 84 is being scribed in the scribing station 82.

FIG. 4 schematically illustrates example laser-scanning assemblies, in accordance with many embodiments, configured for vertical translation relative to a vertically-oriented workpiece 92. Such laser-scanning assemblies can be used with a system such as those described above. A first laser-scanning assembly 94 can be coupled with a first laser source 96 by way of a first optical path 98 (e.g., an optical fiber, an optical path). A second laser-scanning assembly 100 can be coupled with a second laser source 102 by way of a second optical path 104. The laser-scanning assemblies can be configured to move in opposite directions so as to minimize any unbalanced forces that may arise due to the movement of the scanning assemblies. For example, by having the first laser-scanning assembly 94 move in the opposite direction of the second laser-scanning assembly 100 the resulting forces generated by the acceleration of the assemblies cancel out so that there is no resulting force on a frame holding these assemblies. The scanning assemblies can be configured to translate using known approaches, for example, by using a robotic arm, a rail, a gantry, or any other known mechanism. Each optical assembly can include one or more separate laser-scanning heads 106, which can be used to control the position on the workpiece of output from the laser source in one or more dimensions relative to the scanning head. A combination of the local control provided by a scanning head, the number and placement of scanning heads, the vertical and optionally horizontal movement of a scanning assembly, and the horizontal movement of the workpiece can be used to scribe desired areas of the workpiece. Fiber-optic cables can be used to couple a scanning assembly with a laser source. The use of fiber-optic cables may reduce the weight of moving parts, thereby helping to reduce movement induced forces and/or vibrations. In many embodiments, the use of fiber-optic cables would also eliminate the need for complex optical alignment.

A variety of potential variations can be employed. For example, although the workpiece 92 is shown as being clamped at the top and bottom, optionally the workpiece can be clamped on the sides, or on any combination of the top, bottom and sides. In many embodiments, the workpiece is translated at low speeds (e.g., 5 to 10 mm/sec) during the scribing process, for example, via a ball screw over a range of travel (e.g., 275 mm). In many embodiments, the laser-scanning assemblies 94, 100 produce eight beams and are spaced apart at 275 mm spacing in the horizontal direction. In many embodiments, the laser-scanning assemblies 94, 100 are equipped with two-dimensional laser-scanning heads 106 with a field-of-view (FOV) of approximately 60 mm. In many embodiments, the laser-scanning assemblies 94, 100 are translatable in the vertical direction at a relatively high speed (e.g., 0.5 to 2 or more meters/sec). In many embodiments, the laser-scanning assemblies 94, 100 are supported via air bearings. In many embodiments, the laser-scanning assemblies 94, 100 have a total travel of approximately 3 meters. In many embodiments, the laser-scanning heads 106 compensate for movement of the workpiece during the scribing process (e.g., via bowtie scanning). In many embodiments, the laser-scanning assemblies 94, 100 move in opposite directions to minimize motion induced forces. In many embodiments, the laser-scanning assemblies 94, 100 are translatable in the z direction (i.e., in and out of the plane of the figure) to compensate for the location of each workpiece. In many embodiments, lateral trim lines can be produced using scanner stitching during vertical motion of the laser-scanning assemblies.

In many embodiments, each workpiece is moved continually in a first direction, wherein the scan field for each beam portion forms a scribe line moving “up” or “down” the workpiece. The laser repetition rate can be matched to the stage translation speed, with a necessary region of overlap between scribe positions for edge isolation. At the end of a scribing pass up or down the workpiece, each scanning assembly can decelerate, stop, shift as necessary, and re-accelerate in the opposite direction. In this case, the laser optics are stepped according to the required pitch so that the series of ablation spots used to form the scribe lines are laid down at the required positions on the glass substrate. If the scan fields overlap, or at least substantially meet within a pitch between successive scribe lines, then the substrate does not need to be moved relative to the laser-scanning assemblies, but the beam position can be adjusted between “up” and “down” movements of the laser-scanning assemblies in the laser-scribe device. In many embodiments, the laser can scan across the workpiece making a scribe mark at each position of a scribe line within the scan field, such that multiple scribe longitudinal scribe lines can be formed at the same time with only one complete pass of the laser-scanning assemblies being necessary. Many other scribe strategies can be supported as would be apparent to one of ordinary skill in the art in light of the teachings and suggestions contained herein.

Laser Assemblies

Further, while four lasers are shown for each of two scanning assemblies for a total of eight active beams, it should be understood that any appropriate number of lasers and/or beam portions can be used as appropriate, and that a beam from a given laser can be separated into as many beam portions as is practical and effective for the given application. Further, even in a system where two lasers produce eight beam portions, fewer than eight beam portions can be activated based on the size of the workpiece or other such factors. Optical elements in the scan heads also can be adjusted to control an effective area or spot size of the laser pulses on the workpiece, which in many embodiments vary from about 25 microns to about 100 microns in diameter.

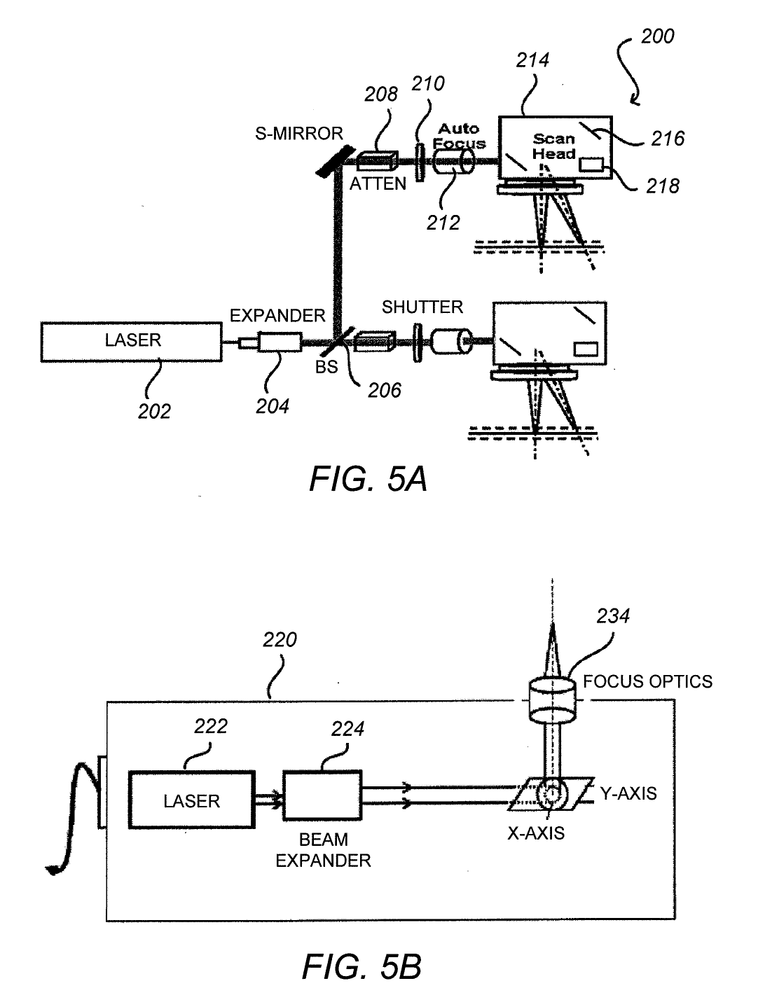

Each laser-scanning assembly can including appropriate elements, such as lenses and other optical elements, needed to focus or otherwise adjust aspects of the laser beam. The laser device generating the beam can be any appropriate laser device operable to ablate or otherwise scribe at least one layer of the workpiece, such as a pulsed solid-state laser. In order to provide the pair of beams, each laser assembly can include at least one beam-splitting device. FIG. 5A illustrates basic elements of an example laser assembly 200 that can be used in accordance with many embodiments, although it should be understood that additional or other elements can be used as appropriate. In this assembly 200, a single laser device 202 generates a beam that is expanded using a beam collimator 204 then passed to a beam splitter 206, such as a partially transmissive mirror, half-silvered mirror, prism assembly, etc., to form first and second beam portions. In this assembly, each beam portion passes through an attenuating element 208 to attenuate the beam portion, adjusting an intensity or strength of the pulses in that portion, and a shutter 210 to control the shape of each pulse of the beam portion. Each beam portion then also passes through an auto-focusing element 212 to focus the beam portion onto a scan head 214. Each scan head 214 includes at least one element capable of adjusting a position of the beam, such as a galvanometer scanner useful as a directional deflection mechanism. In many embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved. Accordingly, the scribe lines can be formed more precisely (i.e., a scribe 1 line can be closer to a scribe 2 line) such that the efficiency of a completed solar module is improved over that of existing techniques.

In many embodiments, each scan head 214 includes a pair of rotatable mirrors 216, or at least one element capable of adjusting a position of the laser beam in two dimensions (2D). Each scan head includes at least one drive element 218 operable to receive a control signal to adjust a position of the “spot” of the beam within the scan field and relative to the workpiece. In some embodiments, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. The ability to laterally scan the beam (e.g., in one or more dimensions) means that any pattern can be formed on the workpiece via scribing without having to rotate the workpiece. Additionally, the ability to laterally scan the beam allows for vertical lines to be scribed on the glass by combining the motion of the glass in the horizontal direction, the motion of the optics assembly in the vertical direction, and positional scanning by the scanner so that the resulting scribe on the glass is parallel to the vertical edge of the glass, an approach that is sometimes referred to as bow-tie scanning.

FIGS. 5B and 5C show a side-view illustration and a top-view illustration, respectively, of a compact laser-optics module 220 that can be used in accordance with various embodiments. The compact module 220 includes a laser 222, a beam collimator 224, a beam splitter 226, a mirror 228, one or more scanning mirrors 230, 232, and one or more focusing optical assemblies 234. The laser 222 can comprise a range of existing lasers. For example, the laser 222 can comprise a lightweight, small footprint laser. Existing second harmonic solid state lasers of sufficient power for scribing thin-film solar panel scribe lines can be made as light as 1 kg with a size of approximately 150 mm by 100 mm by 50 mm. A laser power supply and/or chiller can be located exterior to the compact module 220. The laser 222 generates a beam that is collimated using the beam collimator 224. The beam collimator 224 can be used to change the size of the laser beam and can be coupled with the laser 222, for example, attached to the laser adjacent to the output of the laser 222. The beam splitter 226 receives the collimated beam from the collimator 224 and splits the collimated beam into two nominally equal beam portions. In many embodiments, a power-attenuation aperture (not shown) can be placed along each beam path to finely adjust laser power and beam size. In many embodiments, an attenuating element (see attenuating element 208 in FIG. 5A) can be placed along each beam path to attenuate the beam portion, adjusting an intensity or strength of the pulses in that portion. In many embodiments, a shutter (see shutter 210 in FIG. 5A) can be placed along each beam path to control the shape of each pulse of the beam portion. In many embodiments, an auto-focusing element (see auto-focusing element 212 in FIG. 5A) can be placed along each beam path to focus the beam portion onto the one or more scanning mirrors. The one or more scanning mirrors 230, 232 can be actuated about one or more axes, for example, one or more galvanic scanning mirrors can be actuated about an x-axis and a y-axis to provide for two-dimensional scanning of the laser output. In many embodiments, the one or more scanning mirrors 230, 232 comprise individual galvanic scanning mirrors as opposed to a scan head (e.g., scan head 214 in FIG. 5A). Each of the scanned beam portions can then be passed through a focus optical assembly 234, which in many embodiments comprises a telecentric lens.

In many embodiments, the compact module 220 provides the functionality of the laser assembly 200 (shown in FIG. 5A) and various advantages. For example, the layout, rigidity, footprint, and/or weight of the compact module 220 may have a positive direct impact on the reliability and serviceability of the compact module 220 and the whole laser-scribing system. In many embodiments, the use of a single beam collimator before the beam is split may provide a simplified optical beam path and enhanced reliability. In many embodiments, the use of two individual scanning mirrors in place of an enclosed commercial scan head may help to reduce the weight and footprint of the compact module 220, which may serve to improve reliability and serviceability. In many embodiments, the use of a light weight all-in-one box laser module may be easier to install/uninstall and may serve to isolate the optical components from dust, which may reduce the chance for contamination of the optical components.

Sensors

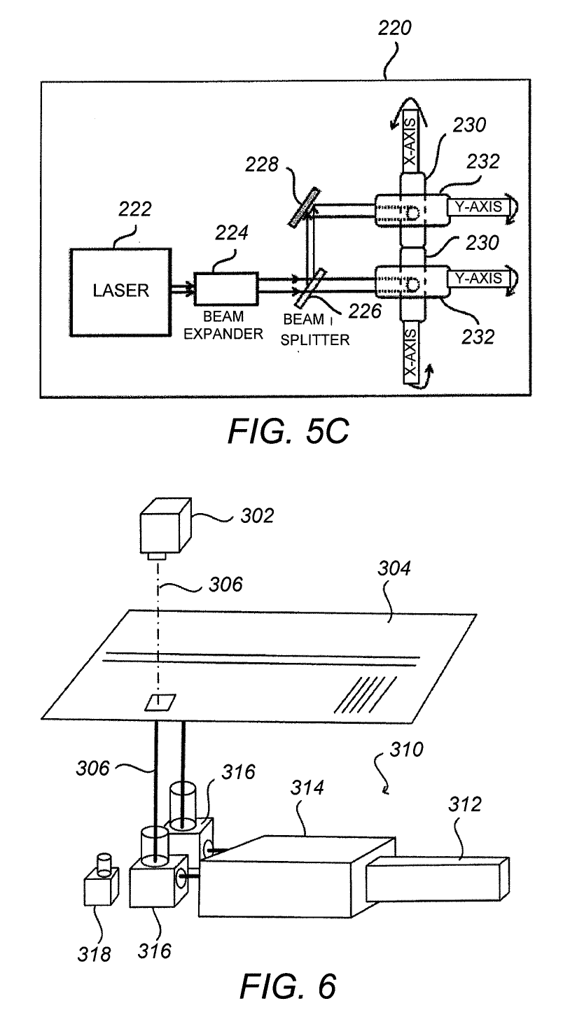

A laser-scribing system can include a number of sensors useful for controlling the scribing of laser lines on a workpiece. For example, as illustrated in FIG. 6, a beam viewer 302 can be used to measure the position of the output from the laser. Data from the beam viewer 302 can be used for rapid recalibration of the beam position. As illustrated, the beam viewer 302 can be positioned relative to a workpiece 304 so as to capture the position of a beam 306 as it passes through the workpiece 304. The expected and the actual position of the beam 306 can be compared to calculate a correction, which can provide a highly accurate adjustment for the correction of any drifts that occur. The beam measured can be projected by a laser assembly 310 that includes a laser 312, beam split optics 314, and scanners 316. As discussed above, the laser assembly 310 can be located on an optics gantry (not shown). A power meter (not shown) can also be positioned on the optics gantry for monitoring the laser power incident on the glass. A microscope (not shown) can also be used. A primary function of the microscope is calibration and alignment of the glass. The microscope can also be used to observe the scribe quality and measure the size of ablation spots. A line sensor 318 can also be used to generate location data for previously formed features. The line sensor 318 can be located in a number of locations from which it can view the previously formed features, for example, relative to the workpiece 304 as illustrated.

Imaging Devices

In many embodiments, one or more cameras is used to optically observe a previously laser-scribed line and align the position of the output from the scribing laser relative to the previously laser-scribed line on the workpiece. In many embodiments, one or more cameras are mounted so that the center of the camera view and the output of a scanning assembly point at the same position on a workpiece. In many embodiments, one or more cameras are mounted to view the workpiece independent of the scanning assemblies.

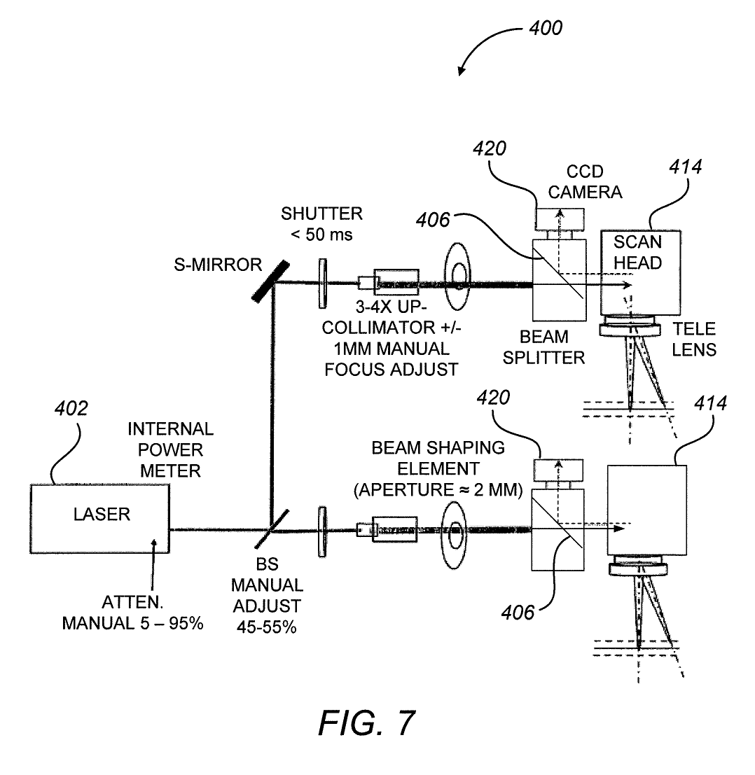

FIG. 7 schematically illustrates a laser-scanning assembly 400 in accordance with many embodiments. The laser assembly 400 is similar to the previously discussed laser assembly 200 of FIG. 5A, but further includes two imaging devices 420 (e.g., CCD cameras shown) integrated with the laser assembly 400 so that each of the imaging devices 420 can view the workpiece through an associated scanner 414. As shown, each of the imaging devices 420 can be integrated using a dichromatic beam splitter 406 so as provide the imaging device with a view direction that substantially corresponds with the direction along which a separate laser beam portion is provided to each of the scanners 414. As discussed above, although a range of relative positions can be practiced, an imaging device 420 can be integrated with the laser assembly 400 so that the center of its view and the output of the scribing laser 402 point at the same position on a workpiece being targeted by the scanner 414.

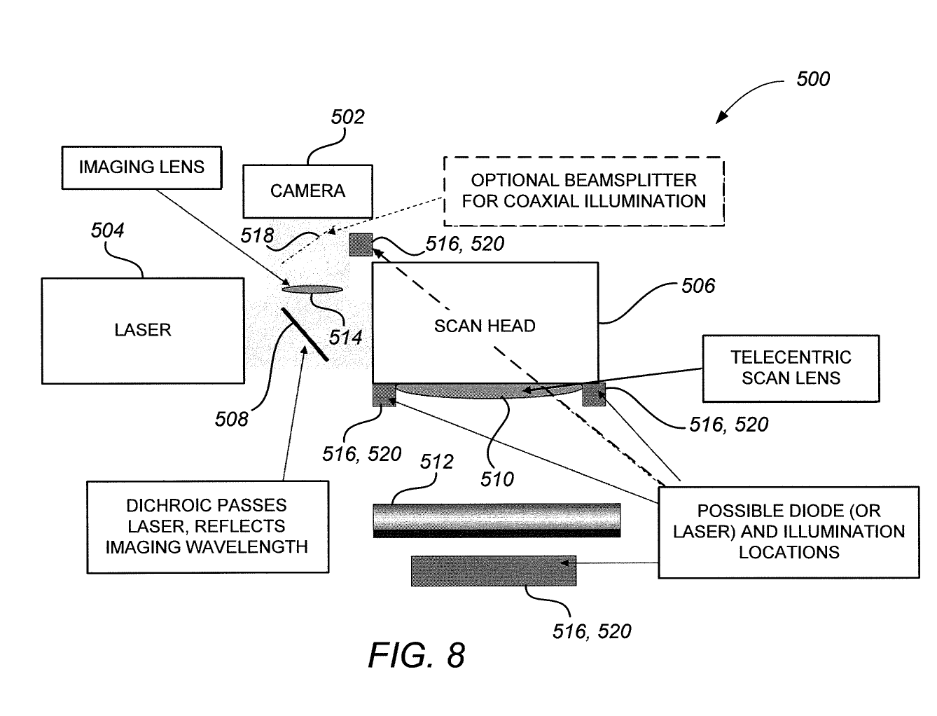

FIG. 8 schematically illustrates a laser-scanning assembly 500 with an integrated camera 502, in accordance with many embodiments. The laser-scanning assembly 500 includes a laser 504 that supplies a laser beam to a scan head 506. The laser beam passes through a dichroic beam splitter 508 on its way to the scan head 506. As described above, the scan head 506 can include at least one element capable of adjusting a position of the laser beam, such as a galvanometer scanner useful as a directional deflection mechanism. The scan head 506 includes a telecentric scan lens 510 that can provide for redirection of a scanned laser beam so as to impinge upon a workpiece 512 in a direction that is substantially normal to the workpiece 512. The laser-scanning assembly 500 includes a camera 502 that is integrated so as to view the workpiece through the scan head. The camera 502 can be used to capture light that is reflected from the workpiece. The reflected light from the workpiece travels through the telecentric lens 510, is redirected by the scan head toward the laser 504, is reflected by the dichroic beam splitter 508, and travels through the imaging lens 514 where the reflected light is received by the camera 502. A photo diode 516, which can be used to measure laser-pulse reflections from the scan lens 510 or from the workpiece 512, can be located in a variety of locations, such as those shown. Where a photodiode 516 is located adjacent to the camera 502, the laser-scanning assembly 500 can include a beam splitter 518 so as to redirect reflected light toward the photodiode. An illumination sources 520 can also be used to supply illumination used for image capture. The illumination sources 520 can be located in various locations, for example, in the locations shown.

Control Systems

A Vertically-oriented workpiece scribing system can include a control system operable to control the movement of the fixtures, the movement of the scanning assemblies, the operation of the lasers and scanning devices, etc. The control system can include any appropriate combination of hardware and software, and can include any appropriate motor or drive mechanisms necessary for operation. The system can include any number of sensors or monitors, and can include one or more feedback systems to monitor and adjust operation.

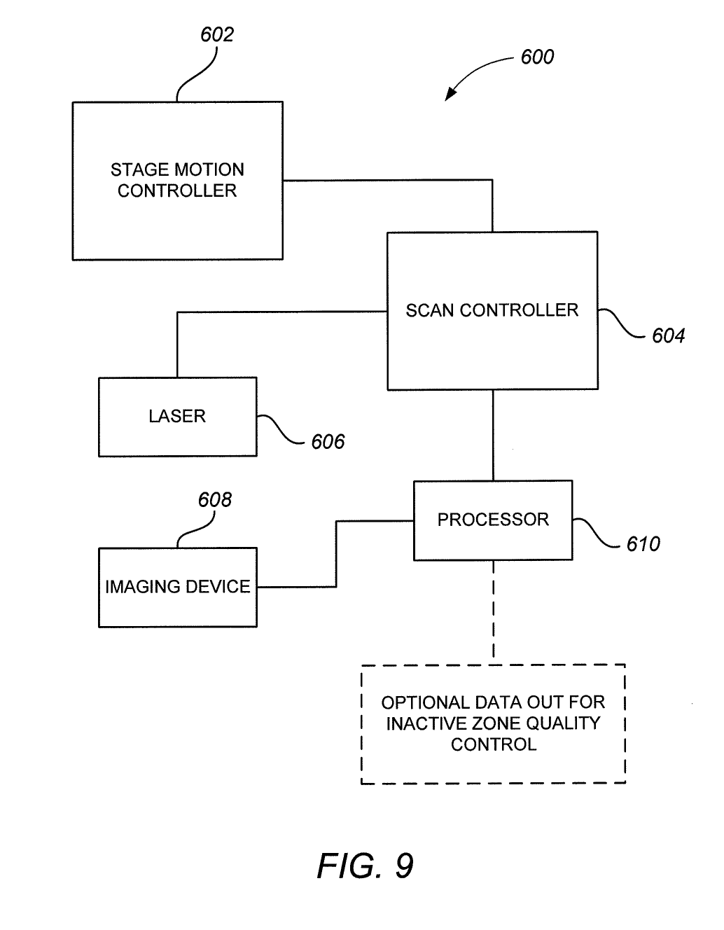

FIG. 9 diagrammatically illustrates signals between components of a scribing system 600, in accordance with many embodiments. A stage motion controller 602 can be used to move a workpiece relative to a scan head. Alternatively, the scan head can be moved relative to the workpiece or a combination of movement of the workpiece and the scan head can be used. The stage motion controller 602 can transfer its positional information to a scan controller 604, including start and stop signals. The scan controller 604 can send fire control signals to a laser 606, including first pulse suppression and off signals. As describe above, an imaging device 608 can supply image-derived data regarding the positions of features on the workpiece to a processor 610. The processor 610 can generate a correction signal that can be supplied to the scan controller 604 for the correction of subsequently commanded scan locations of a scan head used to target output from the laser 606 on the workpiece. At the beginning of the formation of a scribe line relative to a previously-formed scribed line, excess space can be allowed. As the formation of the scribe line progresses, the control system can rapidly close in on a desired line spacing. The system can operate to track lines and maximize active area by keeping P1 close to P2 and P3 close to P2.

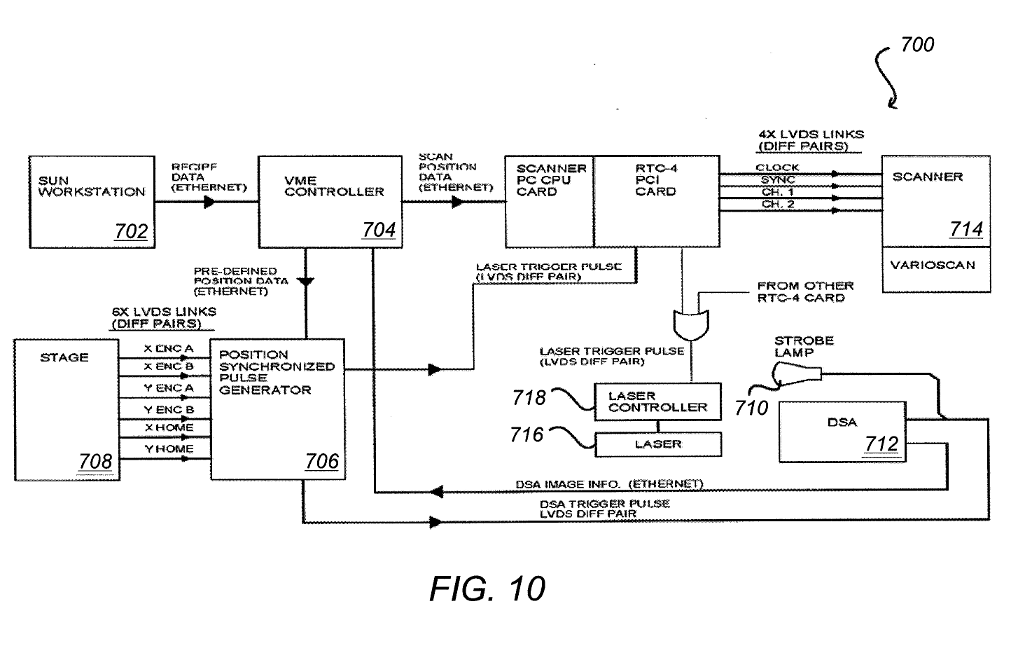

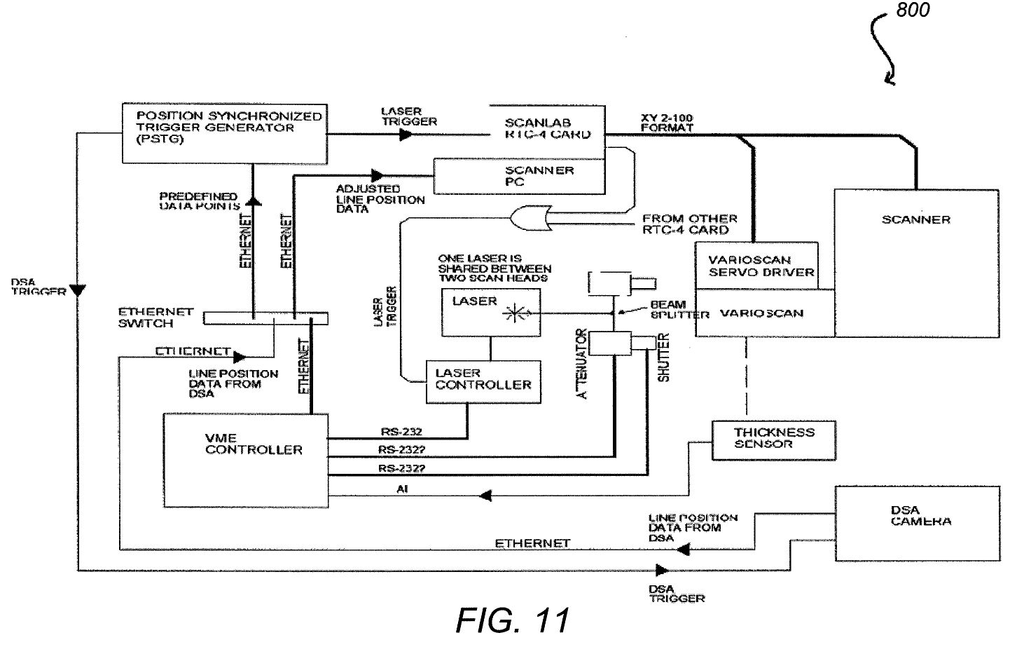

FIG. 10 illustrates a control system 700 that can be used for a laser-scribe device in accordance with many embodiments, although many variations and different elements can be used as would be apparent to one of ordinary skill in the art in light of the teachings and suggestions contained herein. In this system, a workstation 702 works through a Virtual Machine Environment (VME) controller 704, such as by using an Ethernet connection, to work with a pulse generator 706 (or other such device) for driving the workpiece translation stage 708 and controlling a strobe lamp 710 and an imaging device 712 for generating images of the scribe position(s). The workstation also works through the VME controller 704 to drive the position of each scanner 714, or scan head, to control the spot position of each beam portion on the workpiece, and to control the firing of the laser 716 via a laser controller 718. FIG. 11 illustrates a flow of data 800 through these various components.

In many embodiments, scribe placement accuracy is guaranteed by synchronizing the workpiece translation stage encoder pulses to the laser and spot placement triggers. The system can ensure that the workpiece is in the proper position, and the scanners directing the beam portions accordingly, before the appropriate laser pulses are generated. Synchronization of all these triggers is simplified by using the single VME controller to drive all these triggers from a common source. Various alignment procedures can be followed for ensuring alignment of the scribes in the resultant workpiece after scribing. Once aligned, the system can scribe any appropriate patterns on a workpiece, including fiducial marks and bar codes in addition to cell delineation lines and trim lines.

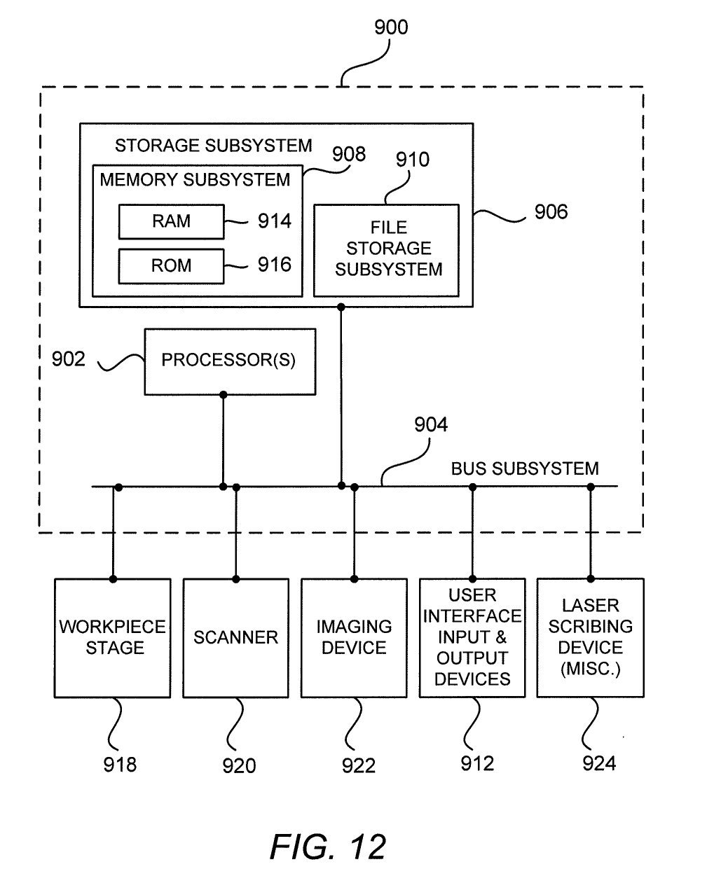

FIG. 12 is a simplified block diagram of a control system 900 that can be used, in accordance with embodiments. The control system 900 can include at least one processor 902, which can communicate with a number of peripheral devices via bus subsystem 904. The peripheral devices can include a storage subsystem 906, which includes, for example, a memory subsystem 908 and a file storage subsystem 910. The storage subsystem 906 can maintain basic programming and data constructs that can be used to control a patterning device. The peripheral devices can also include a set of user interface input and output devices 912.

The user interface input devices can include a keyboard and may further include a pointing device and a scanner. The pointing device can be an indirect pointing device such as a mouse, trackball, touchpad, or graphics tablet, or a direct pointing device such as a touch screen incorporated into the display. Other types of user interface input devices, such as voice recognition systems, are also possible.

User interface output devices can include a printer and a display subsystem, which can include a display controller and a display device coupled to the controller. The display device can be a cathode ray tube (CRT), a flat-panel device such as a liquid crystal display (LCD), or a projection device. The display subsystem can also provide non-visual display such as audio output.

The memory subsystem 908 typically includes a number of memories including a main random access memory (RAM) 914 for storage of instructions and data during program execution and a read only memory (ROM) 916 in which fixed instructions are stored.

The file storage subsystem 910 provides persistent (non-volatile) storage for program and data files, and typically includes at least one hard disk drive and at least one disk drive (with associated removable media). There may also be other devices such as a CD-ROM drive and optical drives (all with their associated removable media). Additionally, the system may include drives of the type with removable media cartridges. One or more of the drives may be located at a remote location, such as in a server on a local area network or at a site on the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. The bus subsystem 904 is shown schematically as a single bus, but a typical system has a number of buses such as a local bus and one or more expansion buses (e.g., ADB, SCSI, ISA, EISA, MCA, NuBus, or PCI), as well as serial and parallel ports.

Discussion of the remaining items of FIG. 12 will be omitted here due to being discussed above, such as a workpiece stage 918, a scanner 920, an imaging device 922, and other miscellaneous laser-scribing device 924 components.

Additional Features

In many embodiments, a laser-scribing system includes one or more additional features. For example, an exhaust hood or other exhausting means can be positioned to extract material ablated from a workpiece. In many embodiments, there is at least one exhaust for each workpiece. In many embodiments, the layers to be scribed are on the opposite side of the workpiece from the scanning assemblies, such that the laser beams pass through the substrate to scribe the layers, thus causing the material to ablate off the surface where it can be extracted by an exhaust system.

Additional devices, apparatus, systems, and methods that can be used with the presently disclosed laser-scribing tool architecture and methods are described in numerous patent applications assigned to Applied Materials, Inc. including, for example, in U.S. patent application Ser. No. 12/422,189 entitled “LASER SCRIBING PLATFORM AND HYBRID WRITING STRATEGY,” filed Apr. 10, 2009; U.S. patent application Ser. No. 12/422,200 entitled “LASER-SCRIBING PLATFORM,” filed Apr. 10, 2009; U.S. patent application Ser. No. 12/422,224 entitled “LASER SCRIBE INSPECTION METHODS AND SYSTEMS,” filed Apr. 10, 2009; U.S. patent application Ser. No. 12/422,208 entitled “DYNAMIC SCRIBE ALIGNMENT FOR LASER SCRIBING, WELDING OR ANY PATTERNING SYSTEM,” filed Apr. 10, 2009; U.S. patent application Ser. No. 12/430,249 entitled “DEBRIS-EXTRACTION EXHAUST SYSTEM,” filed Apr. 27, 2009; and U.S. patent application Ser. No. 12/430,345 entitled “IN-SITU MONITORING FOR LASER ABLATION,” filed Apr. 27, 2009, the entire disclosures of which are hereby incorporated herein by reference.

It is understood that the examples and embodiments described herein are for illustrative purposes and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. An apparatus for laser scribing a workpiece comprising a substantially flat surface, the apparatus comprising:
a frame;
a first fixture coupled with the frame, the first fixture being configured for engagement with a first portion of the workpiece;
a second fixture coupled with the frame, the second fixture being configured for engagement with a second portion of the workpiece, wherein when the workpiece is engaged by the first and second fixtures the flat surface is substantially vertically oriented;
a laser operable to generate output able to remove material from at least a portion of the workpiece; and
a scanning device coupled with the laser and the frame, the scanning device operable to control a position of the output from the laser relative to the workpiece.

2. The apparatus of claim 1, wherein:
the workpiece is substantially rectangular and comprises a first side and a second side opposite the first side;
the first fixture is configured to engage the workpiece along the first side; and
the second fixture is configured to engage the workpiece along the second side.

3. The apparatus of claim 2, wherein when the workpiece is engaged by the first and second fixtures:
the first side is disposed at the top of the workpiece; and
the second side is disposed at the bottom of the workpiece.

4. The apparatus of claim 2, wherein when the workpiece is engaged by the first and second fixtures, the first and second sides are substantially vertically oriented.

5. The apparatus of claim 1, wherein the first and second fixtures are horizontally translatable relative to the frame.

6. The apparatus of claim 5, comprising:
a third fixture coupled with the frame, the third fixture configured to engage a second workpiece along a first side of the second workpiece; and
a fourth fixture coupled with the frame, the fourth fixture configured to engage the second workpiece along a second side of the second workpiece, wherein
when the second workpiece is engaged by the third and fourth fixtures a flat surface of the second workpiece is substantially vertically oriented, and
the third and fourth fixtures are horizontally translatable relative to the frame.

7. The apparatus of claim 6, wherein the second workpiece can be loaded while the workpiece is being scribed.

8. The apparatus of claim 7, wherein the workpiece can be unloaded while the second workpiece is being scribed.

9. The apparatus of claim 8, wherein a path of travel for the workpiece is offset from a path of travel for the second workpiece.

10. The apparatus of claim 9, wherein the scanning device is horizontally translatable so as to adjust for the offset between the paths of travel for the workpiece and the second workpiece.

11. The apparatus of claim 1, wherein the scanning device is vertically translatable relative to the workpiece.

12. The apparatus of claim 11, wherein the scanning device is vertically translatable relative to the frame.

13. The apparatus of claim 1, comprising a second scanning device coupled with the laser and the frame, the second scanning device operable to control a position of the output from the laser relative to the workpiece.

14. The apparatus of claim 13, wherein the scanning device and the second scanning devices are vertically translatable relative to the workpiece.

15. The apparatus of claim 14, comprising:
an optical cable for coupling the laser with the scanning device; and
a second optical cable for coupling the laser with the second scanning device.

16. The apparatus of claim 1, comprising an optical cable for coupling the laser with the scanning device.

17. The apparatus of claim 1, wherein the workpiece comprises a substrate and at least one layer used for forming a solar cell, and the laser is able to remove material from the at least one layer.

18. A system for laser scribing a workpiece comprising a substantially flat surface, the system comprising:
a frame;
a first fixture coupled with the frame, the first fixture being configured for engagement with a first portion of the workpiece;
a second fixture coupled with the frame, the second fixture being configured for engagement with a second portion of the workpiece, wherein when the workpiece is engaged by the first and second fixtures the flat surface is substantially vertically oriented;
a laser operable to generate output able to remove material from at least a portion of the workpiece;
a scanning device coupled with the laser and the frame, the scanning device operable to control a position of the output from the laser relative to the workpiece; and
a control device coupled with the laser and the scanning device, the control device comprising a processor and a machine-readable medium comprising instructions that when executed by the processor cause the system to align the laser output in order to form a predetermined feature pattern on the workpiece.

19. The system of claim 18, wherein the scanning device is vertically translatable relative to the workpiece.

20. The system of claim 19, wherein the first and second fixtures are horizontally translatable relative to the frame.

21. A method for laser scribing a workpiece comprising a substantially flat surface, the method comprising:
supporting the workpiece so that the flat surface is substantially vertically oriented;
generating a relative translation between the supported workpiece and a scribing optical assembly, the relative translation comprising a vertical component; and
directing output from a laser with the scribing optical assembly during the relative translation to form a laser-scribed feature on the workpiece.

22. The method of claim 21, wherein the relative translation further comprises a horizontal component.

23. The method of claim 22, wherein:
the workpiece is supported with a first fixture engaged with a first portion of the workpiece and a second fixture engaged with a second portion of the workpiece, the first and second fixtures being coupled with a frame and configured to be horizontally translatable relative to the frame;
the scribing optical assembly is coupled with the frame; and
the workpiece is translated horizontally relative to the frame during at least a portion of the formation of the laser-scribed feature.

24. The method of claim 23, further comprising mounting a second workpiece so that the second workpiece is supported by the frame during at least a portion of the formation of the laser-scribed feature.

25. The method of claim 24, wherein the workpiece comprises a substrate and at least one layer used for forming a solar cell, and the laser is able to remove material from the at least one layer.
